(19) United States
(12) Patent Application Publication
(10) Pub. No.: US 2006/0283980 A1
(43) Pub. Date: Dec. 21, 2006

(54) Atomizer system integrated with micro-mixing mechanism

(76) Inventor: Muh Rong Wang, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/155,636

(22) Filed: Jun. 20, 2005

(51) Int. Cl. B05B 7/06; B05B 7/04

(52) U.S. Cl. 239/432; 239/398; 239/427.5; 239/427; 239/428; 239/433

(57) ABSTRACT

An atomizer includes two reservoirs for receiving two different liquids to be atomized and two paths extending from the two reservoirs are merged into a micro-mixing passage which has a nozzle at a distal end thereof. A high pressure reservoir for receiving a gas includes an outlet passage which is connected between the high pressure reservoir and the nozzle. The two liquids are mixed in the micro-mixing passage and hit by the high speed gas coming from the high pressure reservoir so that the two liquids are atomized.

### FIELD OF THE INVENTION

The present invention relates to an atomizer which includes specially designed paths for mixing two different fluid streams and a high speed of gas stream atomizes the mixture to fine particles.

### BACKGROUND OF THE INVENTION

Atomization is an important process in the fields of internal combustion engine, gas turbines, boilers, spraying painting, spraying cooling, spraying drying, powder metallurgy, humidification, or even in cosmetic production. There are three types of atomizers which are pressure atomizers, twin-fluid atomizers and spinning atomizers. The pressure atomizers use a nozzle to atomize the pressurized liquid The twin-fluid atomizers use a high speed of gas flow to hit a liquid flow so as to obtain small particles of the fluid. The spinning atomizers employ eccentric force to atomize liquid into small particles. Nevertheless, the conventional twin-fluid atomizers can only atomize one liquid stream and the result is not satisfied if two or more than two types of liquids are atomized. The new design is proposed that two different liquids are first mixed in a micro path and then hit by the high speed gas flow. However, due to the lower Reynolds numbers, the two types of fluids are separated in the micro path, not a mixture of fluids.

For example, in the cosmetic products, the collagen and the Cellex-C are two liquids with different density, and they can be well absorbed by skin only when they are completely mixed and atomized. However, the collagen and the Cellex-C remain two streams in the micro path due to different density and viscosity so that they are not well atomized to fine particles. This is a common problem for atomizing two different liquids in the micro-atomizer. Hence the design to integrate the micro-atomizer with the micro-mixing mechanisms becomes an important issue in this area.

The present invention intends to provide an atomizer that is able to evenly mix two liquids and the mixture can be well atomized.

### SUMMARY OF THE INVENTION

The present invention relates to an atomizer which includes two reservoirs for receiving two different liquids to be atomized and the two reservoirs have two paths extending there which are merged into a micro-mixing passage which has a nozzle at a distal end thereof. A high pressure reservoir for receiving a gas includes an outlet passage which is connected between the first high pressure reservoir and the nozzle. The two liquids are mixed in the micro-mixing passage and hit by the high speed gas coming from the high pressure reservoir so that the two liquids are atomized.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a first embodiment of the atomizer of the present invention;

FIG. 2 shows a first embodiment of the micro-mixing passage of the present invention;

FIG. 3 shows a second embodiment of the micro-mixing passage of the present invention;

FIG. 4 shows a third embodiment of the micro-mixing passage of the present invention;

FIG. 5 shows a fourth embodiment of the micro-mixing passage of the present invention;

FIG. 6 shows a sixth embodiment of the micro-mixing passage of the present invention;

FIG. 7 shows the system configuration of the second embodiment of the atomizer of the present invention;

FIG. 8 shows the system configuration of the third embodiment of the atomizer of the present invention.

### DETAILED DESCRIPTION OF THE PREFERRED EMBODIMENT

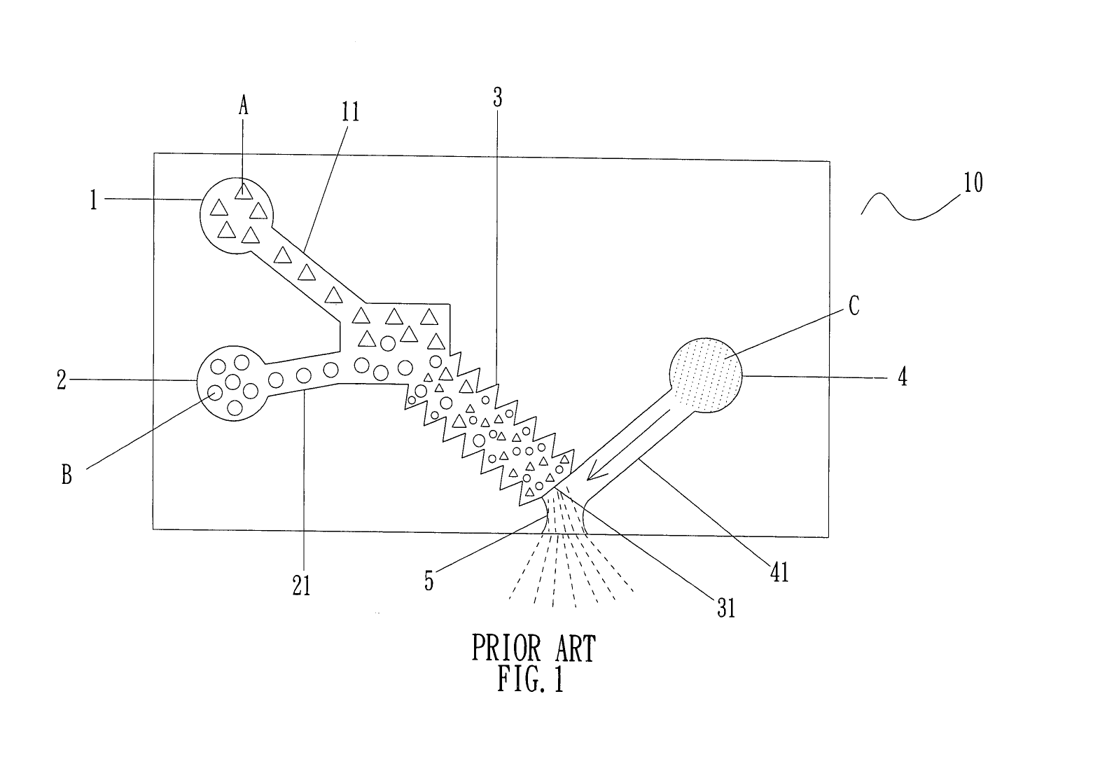

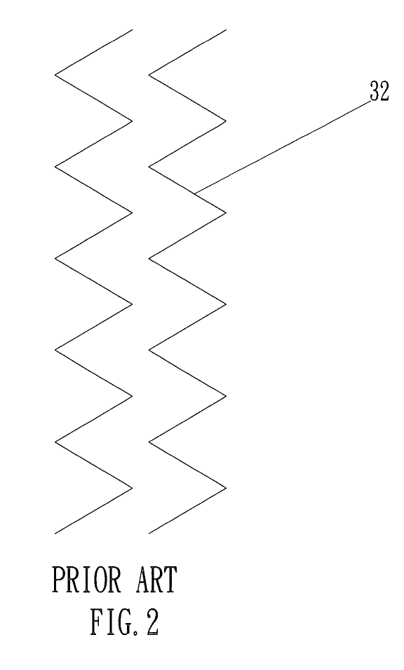

Referring to FIGS. 1 and 2, the atomizer 10 of the present invention comprises two reservoirs 1, 2 in which two different liquids A, B such as collagen and Cellex-C to be atomized are respectively received and each tank 1/2 is connected with a path 11/21. The two respective paths 11, 21 are merged into a micro-mixing passage 3 which has a nozzle 5 at a distal end thereof. The nozzle 5 can be a divergent type, convergent type or convergent-divergent type structure.

A first high pressure reservoir 4 for receiving a gas “C” such as pure oxygen includes a first outlet passage 41 connected between the first high pressure reservoir 4 and the nozzle 5.

The micro-mixing passage 3 includes continuous triangle-shaped protrusions and recesses defined in an inner periphery thereof. The triangle-shaped protrusions and recesses 32 on the two opposite insides are located correspondingly as shown in FIG. 1. The triangle-shaped protrusions and recesses 32 may also be located alternatively to each other in opposite insides of the micro-mixing passage 3 as shown in FIG. 2.

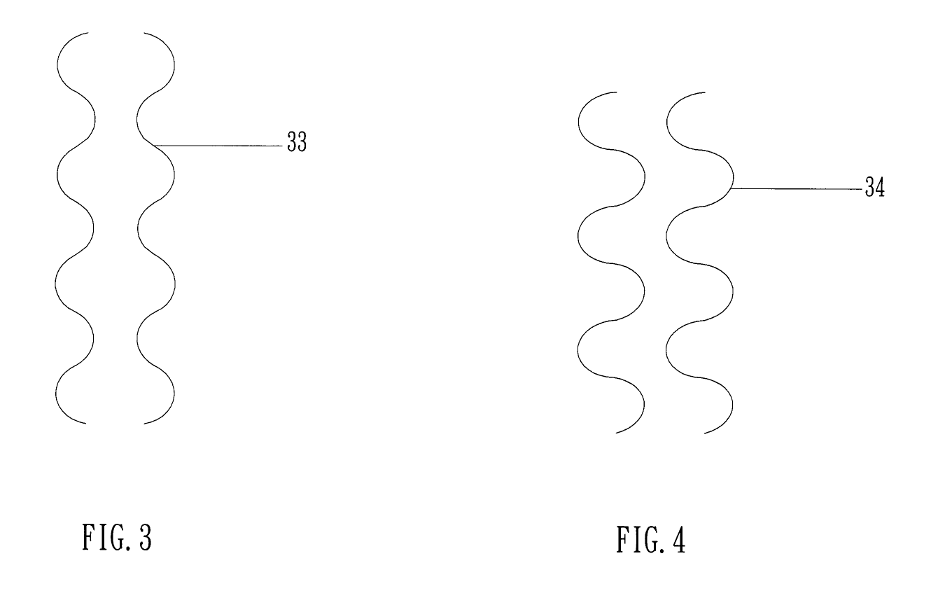

As shown in FIGS. 3 and 4, the micro-mixing passage 3 may include continuous sine-wave protrusions and recesses defined in an inner periphery thereof. The peaks of the sine-wave protrusions on two opposite insides of the micro-mixing passage 3 can be located in alignment with each other as shown in FIG. 3, or the peaks of the sine-wave protrusions on one of two opposite insides of the micro-mixing passage 3 are located in alignment with bottoms of the sine-wave recesses on the other inside as shown in FIG. 4.

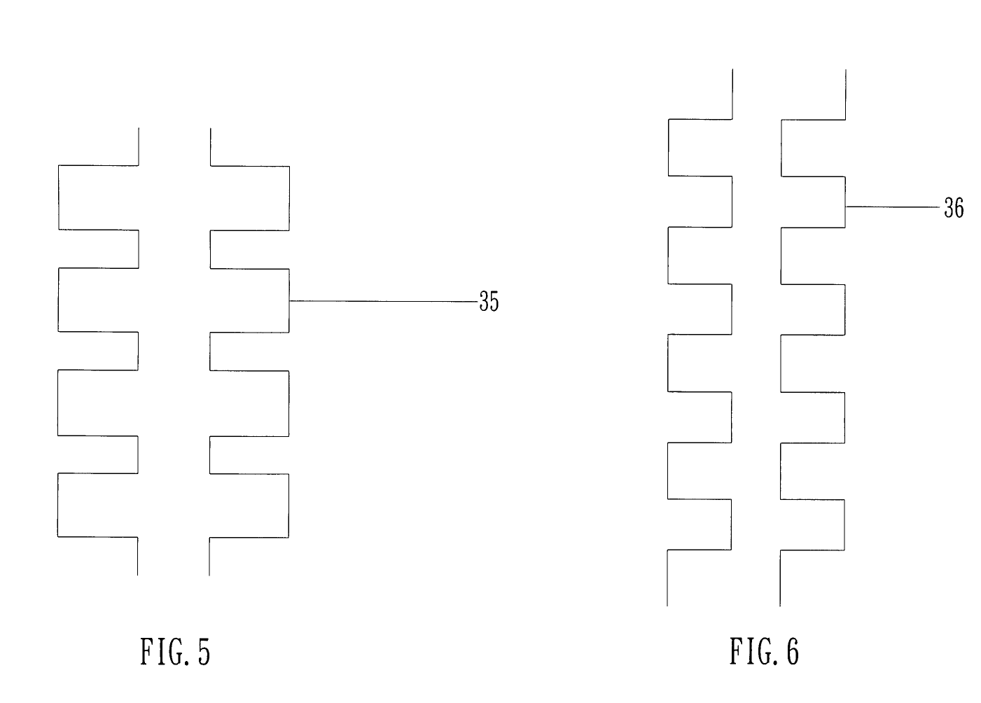

The micro-mixing passage 3 may also include continuous rectangle-shaped protrusions and recesses defined in an inner periphery thereof. The rectangle-shaped protrusions on two opposite insides of the micro-mixing passage 3 can be located in alignment with each other as shown in FIG. 5, or the rectangle-shaped protrusions on one of two opposite insides of the micro-mixing passage 3 are located in alignment with the rectangle-shaped recesses in the other inside as shown in FIG. 6.

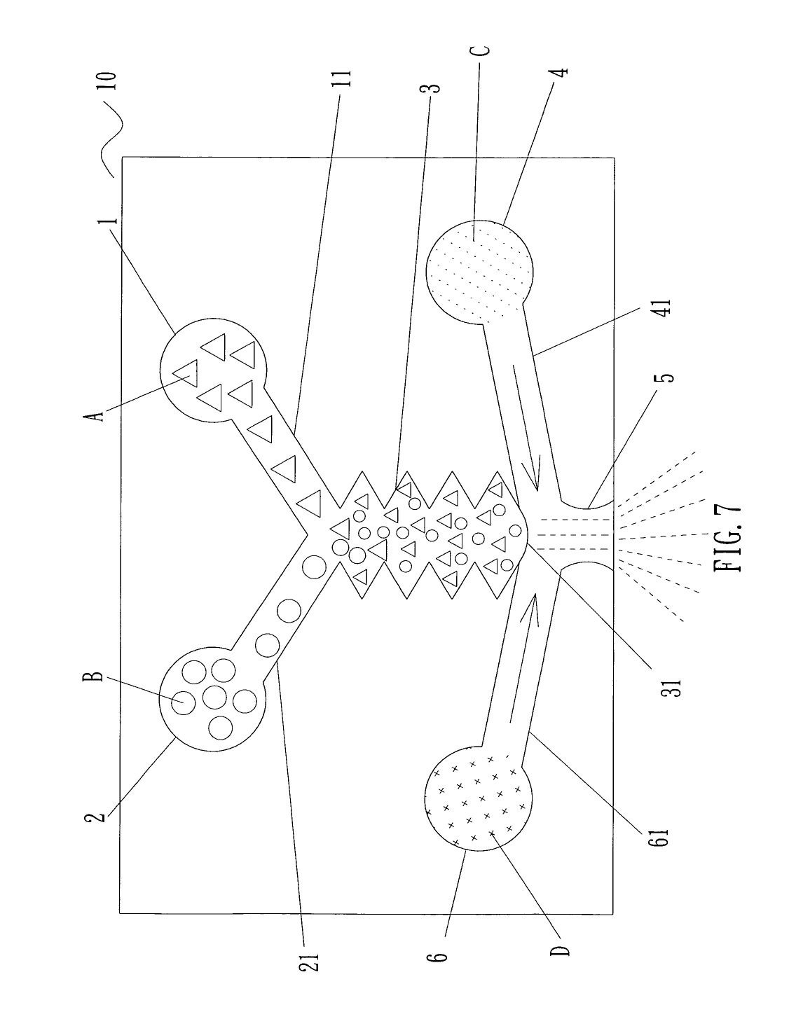

As disclosed in FIG. 7, a second embodiment of the atomizer 10 further comprises a second high pressure reservoir 6 for receiving a gas “D” such as Nitrogen and a second outlet passage 61 is connected between the second high pressure tank 6 and the nozzle 5.

The two liquids “A” and “B” are well mixed in the micro-mixing passage 3 and the particles of the two liquids “A” and “B” are stirred by impact of the special shape of the insides of the micro-mixing passage 3. The mixture of the two liquids “A” and “B” is then hit by the high speed of the gas “C” and “D” so that the liquids “A” and “B” are atomized.

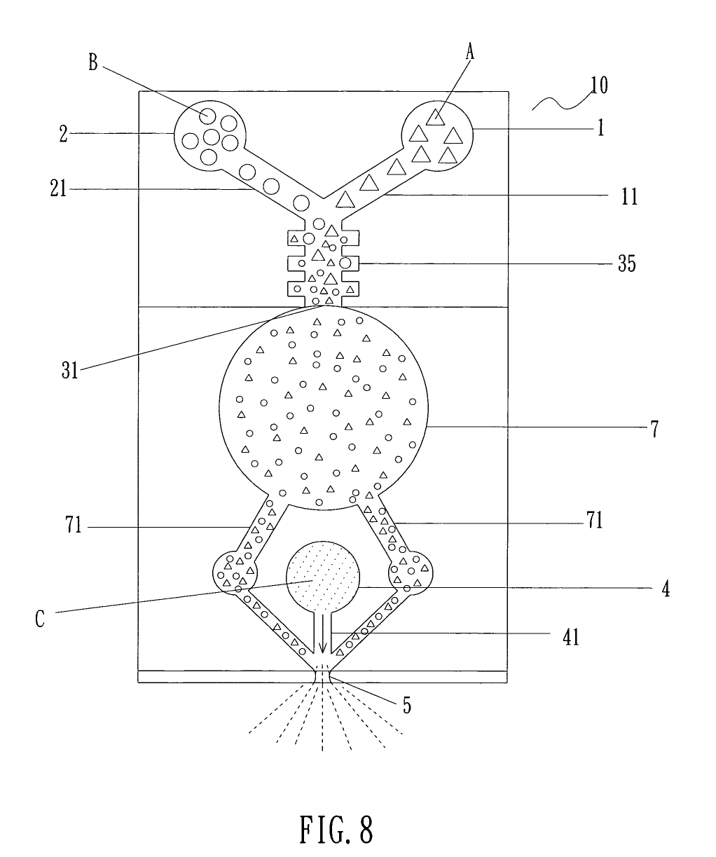

The third embodiment of the present invention is disclosed in FIG. 8 and includes a chamber 7 connected to the nozzle 5 so that the initial mixture of the two liquids “A” and “B” enters the chamber 7 to mix again. The chamber 7 has two sub-paths 71 which are in communication with the first outlet passage 41 of the first high pressure reservoir 4. The two liquids “A” and “B” are mixed twice before being hit by the high speed gas “C”, and this ensures the particles of the mixture to be minimized and even in size.

While we have shown and described the embodiment in accordance with the present invention, it should be clear to those skilled in the art that further embodiments may be made without departing from the scope of the present invention.

What is claimed is:

1. An atomizer comprising:
at least two reservoirs which are adapted to receive two different liquids and each reservoir connected with a path, the two respective paths being merged into a micro-mixing passage which has a nozzle at a distal end thereof, and
a first high pressure reservoir for receiving a gas and a first outlet passage connected between the first high pressure reservoir and the nozzle.

2. The atomizer as claimed in claim 1, wherein the micro-mixing passage includes continuous triangle-shaped protrusions and recesses defined in an inner periphery thereof.

3. The atomizer as claimed in claim 1, wherein the triangle-shaped protrusions and recesses are located alternatively to each other in opposite insides of the micro-mixing passage.

4. The atomizer as claimed in claim 1, wherein the micro-mixing passage includes continuous sine-wave protrusions and recesses defined in an inner periphery thereof.

5. The atomizer as claimed in claim 4, wherein peaks of the sine-wave protrusions on two opposite insides of the micro-mixing passage are located in alignment with each other.

6. The atomizer as claimed in claim 4, wherein the peaks of the sine-wave protrusions on one of two opposite insides of the micro-mixing passage are located in alignment with bottoms of the sine-wave recesses on the other inside.

7. The atomizer as claimed in claim 1, wherein the micro-mixing passage includes continuous rectangle-shaped protrusions and recesses defined in an inner periphery thereof.

8. The atomizer as claimed in claim 7, wherein the rectangle-shaped protrusions on two opposite insides of the micro-mixing passage are located in alignment with each other.

9. The atomizer as claimed in claim 7, wherein the rectangle-shaped protrusions on one of two opposite insides of the micro-mixing passage are located in alignment with the rectangle-shaped recesses in the other inside.

10. The atomizer as claimed in claim 1 further comprising a second high pressure reservoir for receiving a second gas and a second outlet passage is connected between the second high pressure reservoir and the nozzle.

11. The atomizer as claimed in claim 1, wherein a chamber 7 is connected between the nozzle and the first high pressure reservoir and the chamber includes two sub-paths which are in communication with the first outlet passage.
